(19) United States
(12) Patent Application Publication
(10) Pub. No.: US 2025/0227385 A1
(43) Pub. Date: Jul. 10, 2025

(54) IMAGE PROCESSING APPARATUS, IMAGE PICKUP APPARATUS, IMAGE PROCESSING METHOD, AND STORAGE MEDIUM

(71) Applicant: CANON KABUSHIKI KAISHA, Tokyo (JP)

(72) Inventor: TOMOHIRO SUGAYA, Kanagawa (JP)

(21) Appl. No.: 19/089,359

(22) Filed: Mar. 25, 2025

Related U.S. Application Data
(63) Continuation of application No. PCT/JP2023/028690, filed on Aug. 7, 2023.

(30) Foreign Application Priority Data
Oct. 25, 2022 (JP) 2022-170958

(51) Int. Cl. H04N 23/745; H04N 23/67; H04N 23/68; H04N 23/69; H04N 23/695

(52) U.S. Cl. CPC H04N 23/745; H04N 23/675; H04N 23/687; H04N 23/69; H04N 23/695

(57) ABSTRACT

An image processing apparatus includes an image sensor configured to detect an event in a case where a luminance change for each pixel exceeds a predetermined threshold value, and to output an event signal including information on a time of the event and a pixel position at which the event has occurred, a drive unit configured to drive at least one of an optical member constituting at least a part of an imaging optical system and the image sensor so that the luminance change exceeds the predetermined threshold value, and a processor configured to process the event signal output from the image sensor while the drive unit drives the at least one of the optical member or the image sensor, and control a focus lens in the imaging optical system based on a processed image.

### CROSS-REFERENCE TO RELATED APPLICATIONS

This application is a Continuation of International Patent Application No. PCT/JP2023/028690, filed on Aug. 7, 2023, which claims the benefit of Japanese Patent Application No. 2022-170958, filed on Oct. 25, 2022, each of which is hereby incorporated by reference herein in their entirety.

### BACKGROUND

### Technical Field

The present disclosure relates to an image processing apparatus, an image pickup apparatus, an image processing method, and a storage medium.

### Description of Related Art

An image pickup apparatus including an event-driven type vision sensor (event-based sensor) has conventionally been known. The event-based sensor detects an event based on a luminance change for each pixel, and asynchronously outputs an event signal including the time when the event occurred and the pixel position. Thus, the event-based sensor can detect an event when the luminance change exceeds a predetermined threshold value, and has lower latency and lower calculation cost than those in reading out pixel signals from all pixels.

The event-based sensor performs logarithmic conversion of luminance to voltage, and thus can detect a slight luminance difference in a low luminance state. It reacts to a large luminance difference in a high luminance state, prevents an event from being saturated, and provides a wide dynamic range. The event-based sensor has a high time resolution of event information, ranging from several ns to several μs, and causes few object blurs for a moving object.

Japanese Patent Laid-Open No. 2020-182122 discloses an event camera that generates an image (frame data) from an event signal output from an event-based sensor.

The event camera disclosed in Japanese Patent Laid-Open No. 2020-182122 does not output an event signal in a case where no luminance change occurs, so the user cannot confirm the image.

### SUMMARY

An image processing apparatus according to one aspect of the disclosure includes an image sensor configured to detect an event in a case where a luminance change for each pixel exceeds a predetermined threshold value, and to output an event signal including information on a time of the event and a pixel position at which the event has occurred, a drive unit configured to drive at least one of an optical member constituting at least a part of an imaging optical system and the image sensor so that the luminance change exceeds the predetermined threshold value, and a processor configured to process the event signal output from the image sensor while the drive unit drives the at least one of the optical member or the image sensor, and control a focus lens in the imaging optical system based on a processed image. An image pickup apparatus having the above image processing apparatus, an image processing method corresponding to the above image processing apparatus, and a storage medium storing a program that causes a computer to execute the image processing method also constitute another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of an image pickup apparatus according to a first embodiment.

FIG. 2 explains an event generated by an event-based sensor according to the first embodiment.

FIG. 3 illustrates an example of an event image in the first embodiment.

FIGS. 4A to 4C explain a moving amount of an image stabilizing lens according to the first embodiment.

FIGS. 5A to 5F explain an event image in the first embodiment.

FIG. 6 is a block diagram of an image pickup apparatus according to a second embodiment.

FIGS. 7A and 7B explain a method of in-focus determination according to the second embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

### First Embodiment

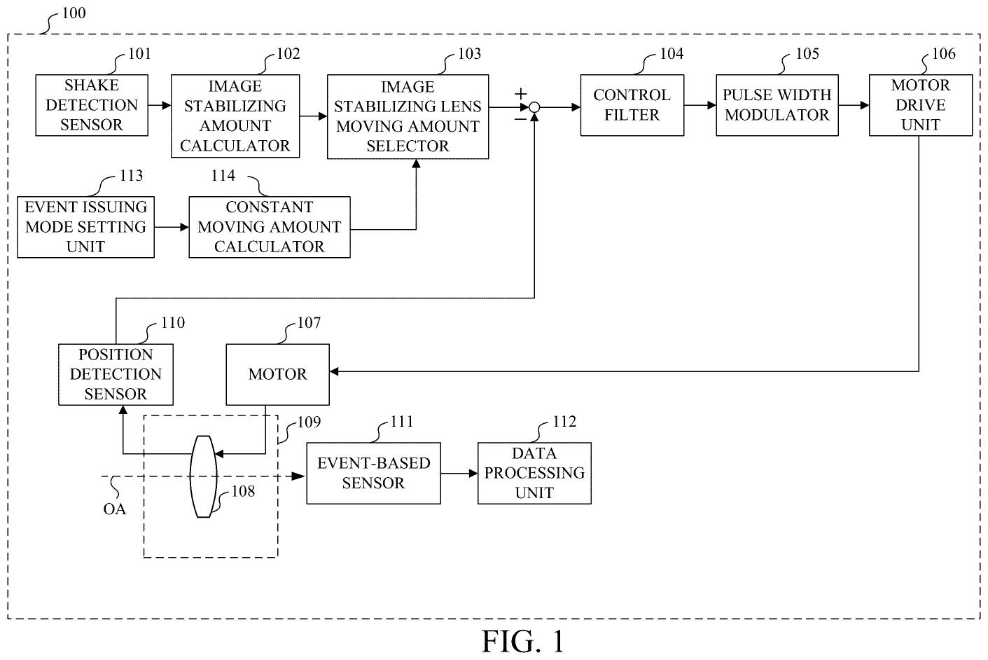

Referring now to FIG. 1, a description will be given of an image pickup apparatus (image processing apparatus) 100 according to a first embodiment. FIG. 1 is a block diagram of the image pickup apparatus 100. The image pickup apparatus 100 includes an event-based sensor (image sensor) 111. The image pickup apparatus 100 further includes an optical image stabilization mechanism.

The image pickup apparatus 100 has at least two modes for switching the application of the optical image stabilization mechanism. One of the two modes is an image stabilizing mode (second mode) in which the stabilization mechanism is driven based on vibrations applied to the image pickup apparatus 100. The other is an event issuing mode (first mode) in which the image stabilizing lens (optical member or element) 108 is driven to issue an event from the event-based sensor 111 (to output an event signal). As will be described in detail later, in the event issuing mode, the image stabilizing lens 108 is minutely driven regardless of vibrations applied to the image pickup apparatus 100. This changes an imaging position of an object image on the event-based sensor 111, and forcibly causes a luminance change for each pixel in the event-based sensor 111. In each embodiment, the vibration applied to the image pickup apparatus will be referred to as “shake,” and an object position shift between frames of a captured image or a blur of an object image caused by the shake applied to the image pickup apparatus will be referred to as “shake.”

The event-based sensor 111 detects a luminance change for each pixel in the imaging range and asynchronously outputs an event signal. The event-based sensor 111 includes a plurality of pixels, for example, arranged in an array, and in a case where a change in a voltage signal (luminance change) that is the logarithm of the light intensity incident on each pixel exceeds a predetermined threshold value, the event-based sensor 111 generates a trigger signal and outputs it as an event signal. The event signal is a signal associated with an event. For example, it includes the time in a case where the occurrence of the event is detected (occurrence time) and the pixel position where the event occurred. The time when the event is detected may be measured based on an internal clock of the event-based sensor 111 (the time of the event-based sensor 111), or may be reset as necessary.

The event signal includes information about the time when the event occurred and the pixel position where the event occurred, and may further include information about the luminance change. The information about the luminance change may be a luminance amount change itself, or information indicating whether the luminance change is positive or negative. The event-based sensor 111 asynchronously outputs an event signal only when a luminance change occurs (in a case where the luminance change exceeds a predetermined threshold value). Here, “asynchronously outputting an event signal” means that the event signal is output independently in time for each pixel, without synchronization with all pixels of the event-based sensor 111.

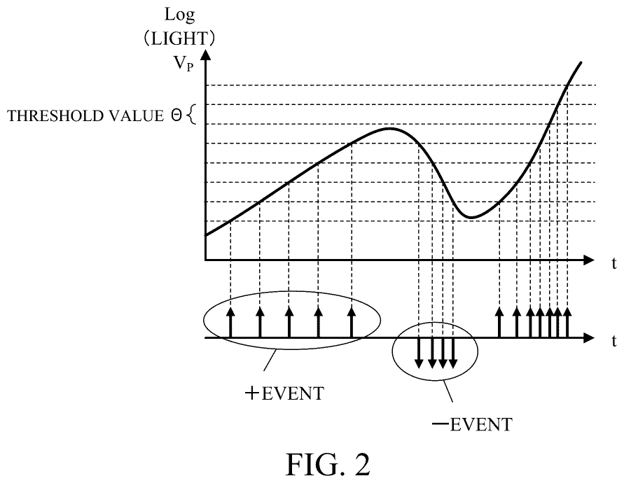

Referring now to FIG. 2, an event generated by the event-based sensor 111 will be described. FIG. 2 explains an event generated by the event-based sensor 111. In FIG. 2, the horizontal axis indicates time t, and the vertical axis indicates voltage Vₚ, which is the logarithm of the light intensity incident on the event-based sensor 111. In FIG. 2, a dotted line drawn horizontally from voltage Vₚ indicates a threshold value (predetermined threshold value) of a voltage signal at which the event-based sensor 111 generates a trigger signal, and is set in units of a voltage change amount (threshold value Θ). The lower diagram in FIG. 2 illustrates an event detecting timing. That is, in a case where the voltage signal (voltage change amount) increases beyond a threshold value Θ (predetermined threshold value), it is indicated by an upward arrow (“+ event”), and in a case where the voltage signal decreases beyond a threshold value Θ, it is indicated by a downward arrow (“− event”).

In FIG. 1, a data processing unit (processor) 112 receives an event signal output from the event-based sensor 111, processes the received event signal, and generates image data (event image) from the event signal. In this embodiment, the data processing unit 112 processes the event signal output from the event-based sensor 111 while the drive unit drives the image stabilizing lens 108, as described below.

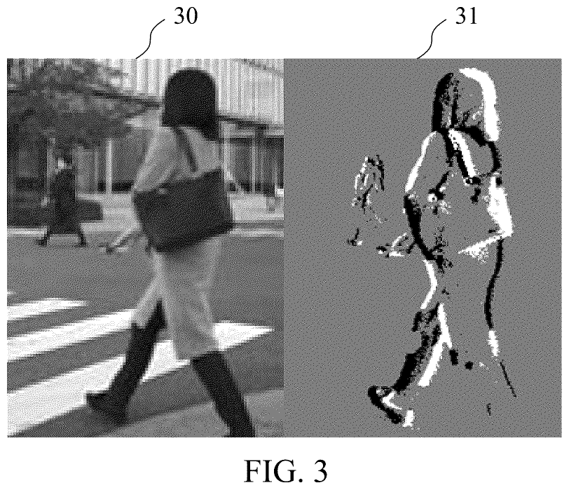

Referring now to FIG. 3, a description will be given of an example of an event image. FIG. 3 illustrates an example of an event image generated based on the event signal output from event-based sensor 111. An image 30 is an image captured by a general image pickup apparatus equipped with an image sensor such as a CMOS image sensor or a CCD image sensor. The image 30 includes detailed data even for a static background portion with no luminance change.

An image 31 is an event image (framed event image) generated as a single frame from a plurality of events that occurred during a period equivalent to a period during which a general image sensor, such as a CMOS image sensor, accumulated light to generate the image 30. In the image 31, black areas (black pixels) represent “− events” and white areas (white pixels) represent “+ events.” Gray areas are pixel areas where no events have occurred. An outline portion of an area where a person is moving (moving from right to left in the image 31) has black or white pixels, and a luminance change can be detected and the movement of the person can be recognized. A static background portion (such as a pedestrian crossing) is a gray area because there is no luminance change. The method of representing each of the black, white, and gray areas is not limited to the above examples, and other colors may be used, and they may be generated by changing pixel values according to the intensity level of the luminance change.

As illustrated in FIG. 3, the image 31 contains significantly less data per predetermined period than the image 30, and post-processing to track or recognize changes in the scene is easier and more efficient. The image 31 generated by the data processing unit 112 can be displayed on an unillustrated output apparatus so that the user can visually recognize it, or the image 31 can be recorded on an unillustrated recording medium in association with the occurrence of an event.

Next follows an image stabilizing function. A shake detection sensor 101 is a sensor that detects shake applied to the image pickup apparatus 100, and is, for example, an angular velocity sensor that detects the angular velocity generated in the image pickup apparatus 100. An image stabilizing amount calculator 102 calculates a target position (movement target position) of the image stabilizing lens 108 based on the output signal of the shake detection sensor 101. The image stabilizing amount calculator 102 has, for example, a high pass filter (HPF) for removing an unnecessary offset output from the output signal of the angular velocity sensor. The image stabilizing amount calculator 102 also has, for example, an integrator for converting angular velocity shake data into angles, a unit conversion unit for converting angle data into units of position information of the image stabilizing lens 108, and a phase compensation filter for compensating for the phase delay of the shake detection sensor 101 itself. An image stabilizing lens moving amount selector 103 selects a proper target position of the image stabilizing lens 108 according to the current mode, based on the target position calculated by the image stabilizing amount calculator 102 and the vibration target position described below. The mode is at least one of two modes, the image stabilizing mode described above and the event issuing mode.

A description will now be given of the control for moving (driving) the image stabilizing lens 108 to the target position output from the image stabilizing lens moving amount selector 103. The image stabilizing lens 108 is driven by feedback control based on the difference data between a signal indicating the target position and the output signal of the position detection sensor 110. The difference data acquired by subtracting the output signal of the position detection sensor 110 from the signal indicating the target position is output to a control filter 104. The control filter 104 performs signal processing such as amplification and phase compensation for the difference data. A pulse width modulator 105 modulates the output data of the control filter 104 into a waveform that changes a duty ratio of a pulsed wave, i.e., a pulse width modulation (PWM) waveform.

A motor drive unit 106 is a circuit that applies a drive signal to a motor 107. For example, the motor drive unit 106 includes an H-bridge circuit, and the motor 107 includes a voice coil motor, but they are not limited to these examples. In this embodiment, the motor drive unit 106 and the motor 107 constitute a drive unit configured to drive the image stabilizing lens 108 so that the luminance change exceeds a predetermined threshold value.

An imaging optical system 109 includes the image stabilizing lens 108 and forms an object image on the event-based sensor 111. The imaging optical system 109 includes, for example, at least one of a zoom lens and a focus lens, but is not limited to them.

The image stabilizing lens 108 includes, for example, a shift lens, and can deflect an optical axis OA by moving in a direction different from a direction along the optical axis OA (optical axis direction). However, the image stabilizing lens 108 is not limited to the shift lens, and another optical member may be used as long as it can deflect the optical axis OA, such as a mechanism (vari-angle prism) that injects liquid between lenses to change the shape of the lenses to deflect the optical axis OA. By moving the image stabilizing lens 108 in accordance with the shake of the image pickup apparatus 100, an image position change in an object caused by the shake of the image pickup apparatus 100 can be canceled by deflecting the optical axis OA, and the imaging position of the object image can be kept at a predetermined position.

The position detection sensor 110 includes a magnet and a Hall sensor. The movement of the image stabilizing lens 108 changes a positional relationship between the magnet and the Hall sensor, and when the magnetic flux density received by the Hall sensor changes, the output of the Hall sensor changes.

An event issuing mode setting unit (setting unit) 113 notifies a constant (or fixed) moving amount calculator 114 that the current mode is the event issuing mode (first mode). The event issuing mode can be selected and set by the user performing a menu operation. The event issuing mode setting unit 113 can set, for example, the event issuing mode (first mode) or the shake correction mode (second mode). The event issuing mode setting unit 113 may be configured to automatically set the event issuing mode in a case where the image pickup apparatus 100 is started or initially set. In a case where the event mode is not selected, as described above, the shake correction mode (second mode) is selected in which the image stabilizing lens 108 is moved based on the shake of the image pickup apparatus 100. However, even if the event issuing mode is not selected, the user can select to enable or disable the image stabilization.

The constant moving amount calculator 114 outputs a constant moving amount that is not related to the shake of the image pickup apparatus 100 as a moving amount of the image stabilizing lens 108. In a case where the image stabilizing lens 108 moves by a constant moving amount, the position of the object image changes by a larger amount than a distance between pixels (pixel pitch) of the event-based sensor 111. In a case where the position of the object image changes by an amount equal to or larger than the pixel pitch of the event-based sensor 111, each pixel detects a luminance change and an event is issued (detected). The movement target position of the image stabilizing lens 108 at this time is set as a vibration target position.

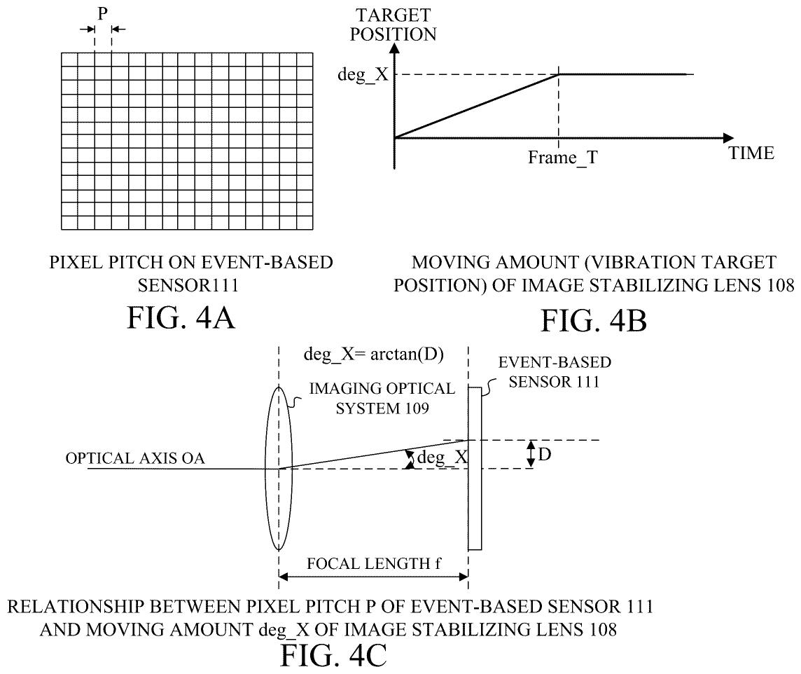

Referring now to FIGS. 4A to 4C, a specific example of the vibration target position will be described. FIGS. 4A to 4C explain the moving amount of the image stabilizing lens 108.

In FIG. 4A, the grating represents pixels arranged in an array on the event-based sensor 111. Assume that pixels are disposed at positions where horizontal and vertical lines intersect, and a distance P corresponds to the pixel pitch. FIG. 4B explains a moving amount of the image stabilizing lens 108 (vibration target position). In FIG. 4B, the horizontal axis indicates time and the vertical axis indicates the target position. The moving amount of the image stabilizing lens 108 is defined as a deflection amount of the optical axis OA, i.e., an angle, and is expressed as deg_X as illustrated in FIG. 4B. Frame_T in FIG. 4B is the exposure time of one frame in the image pickup apparatus 100. FIG. 4B illustrates that the image stabilizing lens 108 is moved by an angle deg_X within the exposure time of one frame. The purpose here is to generate an image in which luminance changes for one frame have been accumulated, as in the image 31. Thus, the purpose can be achieved as long as the movement of the image stabilizing lens 108 is within the time of Frame_T, and the movement may be completed in a time shorter than Frame_T.

Referring to FIG. 4C, a relationship between the distance P between pixels (pixel pitch) and the amplitude (angle deg_X) of the vibration target position will be described. The imaging optical system 109 includes the image stabilizing lens 108, but is illustrated in a simple form for description convenience. In a case where the image stabilizing lens 108 is not moving, the optical axis OA that passes through the imaging optical system 109 passes through approximately the center of the event-based sensor 111. On the other hand, by moving the image stabilizing lens 108, the optical axis OA becomes tilted by an angle deg_X. In a case where the image stabilizing lens 108 moves from a stationary state to a vibration target position, the imaging position of the object image on the event-based sensor 111 changes. Here, D is a change amount in the imaging position.

A focal length f of the imaging optical system 109 is in the same unit as that of the change amount D, for example, millimeters. Here, the angle deg_X can generally be expressed by arctan (D/f). To generate a luminance change in each pixel in the event-based sensor 111, the change amount D at the imaging position on the event-based sensor 111 is to be greater than the distance P between pixels (pixel pitch). For example, D=P may be met, in which the angle deg_X, which is the vibration target position, is expressed as arctan (P/f). Conversion between radians and degrees will be omitted here to simplify the equation.

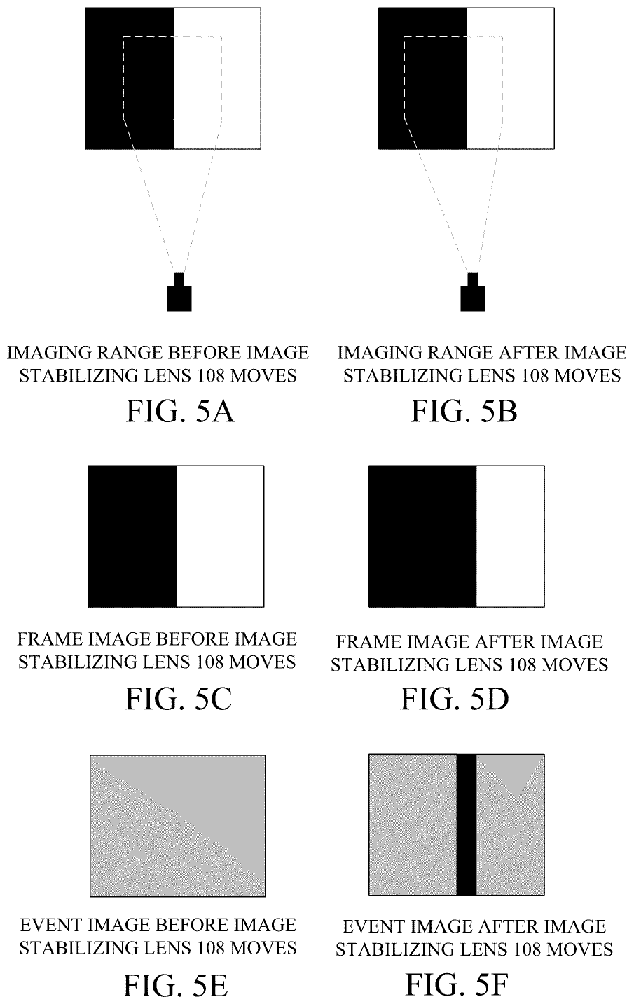

Referring now to FIGS. 5A to 5F, an event image acquired by moving the image stabilizing lens 108 will be described. In this example, assume a chart with a white right side and a black left side. FIG. 5A illustrates an imaging range before the image stabilizing lens 108 moves. In a case where the image stabilizing lens 108 is moved by a predetermined amount, a black area within the imaging range becomes larger. An image acquired through imaging with a general image pickup apparatus including a CMOS image sensor will be referred to as a frame image. A frame image captured in the state of FIG. 5A is an image in FIG. 5C. A frame image captured in the state of FIG. 5B is an image in FIG. 5D.

Here, it is assumed that the image stabilizing lens 108 has not moved before the imaging of FIG. 5A, and in a case where there is no luminance change on the chart, the event-based sensor 111 does not issue any event, and the image illustrated in FIG. 5E is acquired. As described above, this is an image in which areas where no events have occurred are represented in gray, and other color schemes may be used. Among the pixels corresponding to the white portion of the chart before the image stabilizing lens 108 was moved, some pixels correspond to the black portion of the chart after the image stabilizing lens 108 is moved. For this area, the luminance decreases due to the movement of the image stabilizing lens 108, so it becomes black, indicating a negative event, as illustrated in FIG. 5F. Although a simple two-color chart has been described as an example in FIGS. 5A to 5F, by using a similar principle and by moving the image stabilizing lens 108, a fixed object present within an imageable area can be visually recognized as an event image with an extracted outline, as illustrated in FIG. 5F.

According to this embodiment, even if no luminance change occurs within the imaging range in the image pickup apparatus 100 having the event-based sensor 111, the image stabilizing lens 108 is used to slightly shift the imaging position of the object image, and the event can be issued forcibly.

Variations of the method of issuing an event from the event-based sensor 111 are described below.

First, an example using an image stabilizing mechanism will be illustrated. A mechanism may be used in which an actuator is mounted on the event-based sensor 111 (the stage that holds the event-based sensor 111) to move the stage itself. Alternatively, a pan-tilt mechanism may be used that can rotate a camera unit (imaging unit) that integrates the imaging optical system 109 and the event-based sensor 111 up, down, left, and right. In the event issuing mode, the image position of the object image is changed by driving the image stabilizing mechanism by a fixed amount, and an event is issued.

A method may be used in which a light amount passing through the imaging optical system 109 is adjusted to change the luminance value detected by each pixel of the event-based sensor 111, rather than the imaging position of the object image, to issue an event. More specifically, a mechanism (light-amount adjusting unit) for changing a light amount (luminance), such as an aperture stop (diaphragm) or a neutral density filter in the imaging optical system 109, can be used.

An event may be issued by moving a zoom lens or a focus lens constituting the imaging optical system 109 by a small amount in the optical axis direction to change the angle of view.

Each of the above configurations is an event issuing method that utilizes a mechanism for realizing a function that a normal image pickup apparatus has, such as image stabilization or exposure adjustment, but a dedicated mechanism for issuing an event may be provided. For example, a vibration generator may be provided between an imaging unit that integrates the imaging optical system 109 and the event-based sensor 111 and a fixed unit on which the image pickup apparatus is installed. In this case, in a case where an event issuing mode is selected, an event may be issued by changing the positional relationship between the imaging unit and an object using the vibration generator.

Thus, the drive unit can drive at least one of the optical member constituting at least a part of the imaging optical system 109 and the event-based sensor 111 so that the luminance change exceeds a predetermined threshold value. In a case where the drive unit drives the event-based sensor 111, the event-based sensor 111 is movable in a direction including a component orthogonal to the optical axis of the imaging optical system 109. Therefore, in this embodiment, the user can generate an event image at a desired timing, and can perform operations such as setting up an image pickup apparatus (image processing apparatus) while confirming the event image.

### Second Embodiment

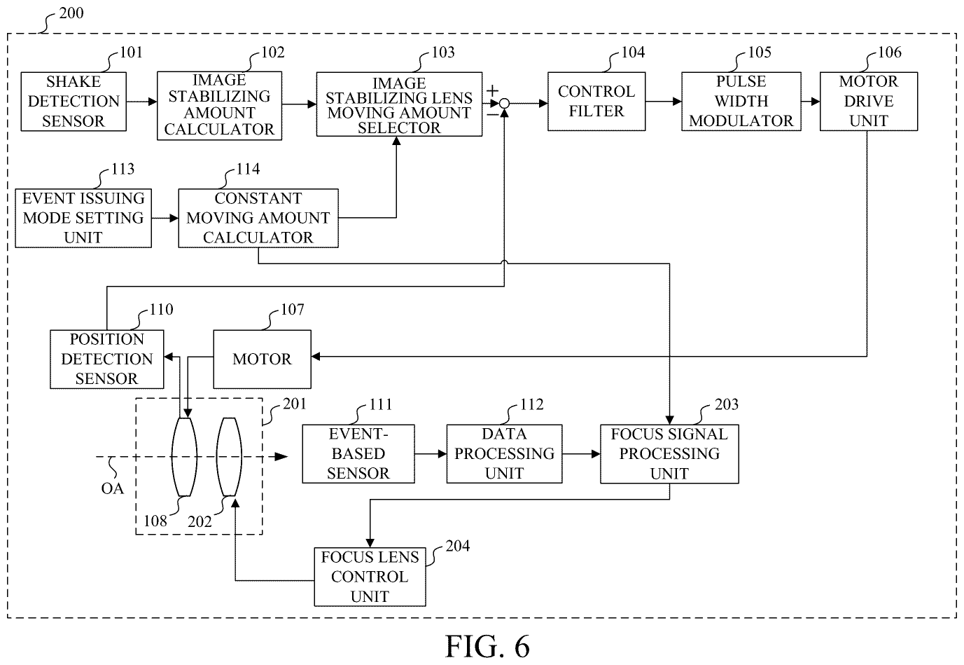

Referring now to FIG. 6, a description will be given of an image pickup apparatus (image processing apparatus) 200 according to a second embodiment. FIG. 6 is a block diagram of the image pickup apparatus 200. The image pickup apparatus 200 includes the event-based sensor 111, similarly to the image pickup apparatus 100 described with reference to FIG. 1. The image pickup apparatus 200 has an autofocus (AF) function in addition to the components of the image pickup apparatus 100.

An imaging optical system 201 includes at least an image stabilizing lens 108 and a focus lens 202. The focus lens 202 is a focus compensator lens that moves in the optical axis direction.

A focus signal processing unit 203 generates a focus signal based on an event image output from the data processing unit 112. The focus signal has a value indicating the sharpness (contrast state) of an image, and represents a focus state of the imaging optical system. In a case where the focus state is an in-focus state, the sharpness is high. In a case where the focus state is a blurred state (non-in-focus state), the sharpness is low. Thus, the focus signal can be used as a value indicating the focus state of the imaging optical system. In addition to the focus signal, the focus signal processing unit 203 generates signals such as a luminance difference signal (a difference between the maximum and minimum luminance levels of an area that is used for focus detection). Regarding the detection of the luminance level, since the event-based sensor 111 does not have a mechanism for detecting absolute luminance information, a sensor capable of detecting luminance (not illustrated) separately from the event-based sensor 111 may be provided. The focus lens control unit 204 drives the focus lens 202 based on the output signal from the focus signal processing unit 203.

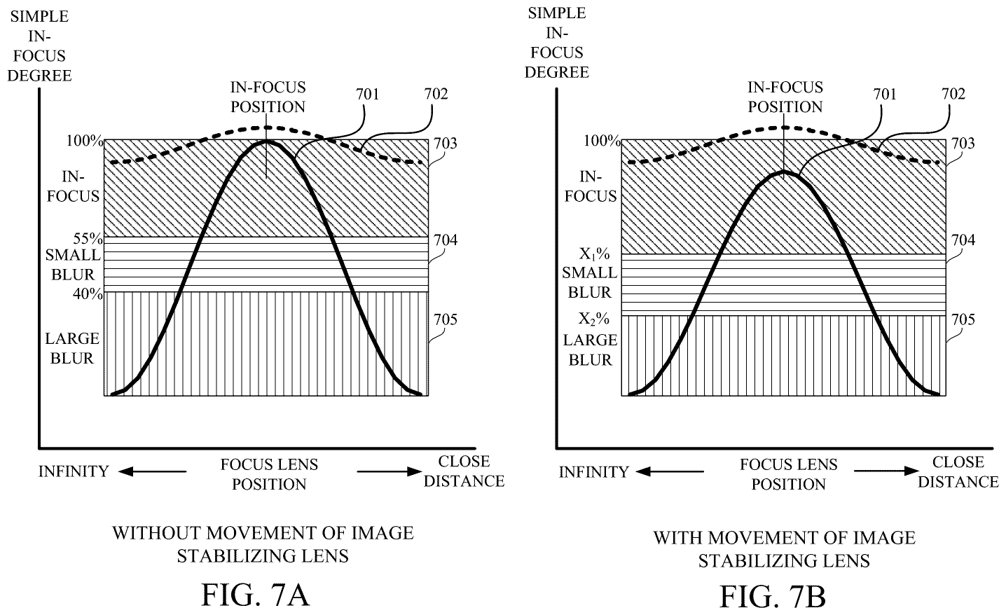

Referring now to FIGS. 7A and 7B, a change in the focus signal according to the position of the focus lens 202 (focus lens position) (in-focus determination method) will be described. FIGS. 7A and 7B explain the change in the focus signal according to the focus lens position for a specified object (in-focus determination method).

As illustrated by a solid line 701 in FIGS. 7A and 7B, the sharpness increases and the value of the focus signal increases as the focus lens position approaches the in-focus position. The value of the focus signal decreases as the focus lens position moves away from the in-focus position. The AF function is a function that searches for a position where the in-focus signal value is maximum by moving the focus lens position while checking the value of the in-focus signal.

An index called a simple in-focus degree may be used to switch the control of the focus lens 202. For example, in a case where the determination using the simple in-focus degree indicates that the image is not in focus, a moving speed of the focus lens 202 is increased so that the image can reach the vicinity of the in-focus point quickly. On the other hand, in an area where the simple in-focus degree indicates the image is in focus, the moving speed of the focus lens 202 is slowed down to perform a detailed search. As described above, a focus signal TEP has a value acquired by extracting high-frequency components from a video signal. Using a difference MMP between the maximum and minimum luminance levels in an area that is used for focus detection, the simple in-focus degree can be calculated by dividing the focus signal TEP by the difference MMP.

A dotted line 702 in FIGS. 7A and 7B illustrates the concept of how the difference MMP changes according to the focus lens position. In FIGS. 7A and 7B, the dotted line 702 illustrates a smaller increase or decrease in value according to the focus lens position compared to the focus signal described above. This is because the maximum and minimum values of the luminance level are approximately the same regardless of the blurred state as long as the object is the same, and the fluctuation of the focus signal due to the object can be suppressed to some extent. Therefore, in this embodiment, in a case where the value of the simple in-focus degree (TEP/MM) is 55% or higher (area 703), it is determined that the state is an in-focus state. On the other hand, in a case where the simple in-focus degree is 40% or higher and less than 55% (area 704), it is determined that the state is in a slightly blurred state (small blur). In a case where the simple in-focus degree is less than 40% (area 705), it is determined that the state is in a significantly blurred state (large blur). Nevertheless, the ratio (determination value) of the simple in-focus degree is not limited to the above ratio.

Here, in a case where the image stabilizing lens 108 is moved to issue an event from the event-based sensor 111, the sharpness of the event image decreases. As described in the first embodiment, the image stabilizing lens 108 is moved by a pixel pitch, i.e., so that the imaging position changes by one pixel, and thus this is a state in which one pixel of object blur occurs. As described above, in a case where the object is the same, the maximum and minimum values of the luminance level can be considered to be approximately the same even if the blurred state changes, so the maximum and minimum values of the luminance level do not change even if the image stabilizing lens 108 is moved. This is as illustrated in the graphs of the solid line 701 and the dotted line 702 in FIGS. 7A and 7B. That is, the simple in-focus degree calculated from the image acquired with the image stabilizing lens 108 moved is lower in value than the simple in-focus degree calculated from the image acquired with the image stabilizing lens 108 not moved.

Therefore, the determination threshold value may be changed in consideration of the fact that the simple in-focus degree in the event issuing mode for issuing an event image by moving the image stabilizing lens 108 is lower than the original value. As illustrated in FIG. 7B, in the forced issuing mode involving the movement of the image stabilizing lens 108, if the simple in-focus degree is X₁% or higher (area 703), this state is determined to be an in-focus state, and if the simple in-focus degree is less than X₂% (area 705), this state is determined to be a significantly blurred state (large blur), and 55<X₁, 40<X₂ are satisfied.

The determination value (ratio) is not limited to the value that is used for this embodiment as long as the threshold value that is used for determination based on the simple in-focus degree in the event issuing mode is lower than the threshold value that is used in an image pickup apparatus equipped with a normal CMOS image sensor. As an example, for X₁ and X₂, one method measures a decrease degree in the simple in-focus degree relative to a moving amount of the image stabilizing lens 108 and previously stores it as table data. The focus signal processing unit 203 acquires the moving amount of the image stabilizing lens 108 from the constant moving amount calculator 114, and acquires X₁ and X₂ corresponding to the acquired moving amount from the table. The focus signal processing unit 203 can make a proper determination even when the image stabilizing lens 108 is moving by using the acquired X₁ and X₂ for the simple in-focus degree determination.

This embodiment performs an AF operation based on the sharpness reduction of the object image caused by moving the image stabilizing lens 108, and can realize AF performance equivalent to that of an image pickup apparatus including a CMOS image sensor. In this embodiment, an object to be driven by the drive unit is not limited to the image stabilizing lens 108 as in the first embodiment, but may be a mechanism for moving a stage mounted with the event-based sensor 111, a vari-angle prism, or a pan-tilt mechanism.

In each embodiment, the image pickup apparatus is a digital camera, but is not limited to this example. Each embodiment is applicable to other devices accompanied by an event-driven type vision sensor. That is, each embodiment is applicable to a mobile phone terminal, a portable image viewer, a television equipped with a camera, a digital photo frame, a music player, a game machine, an electronic book reader, an industrial device, a measuring apparatus, and the like. Each embodiment is not limited to an image pickup apparatus, but is applicable to an image processing apparatus that has no imaging function but has a playback function of moving images.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions. Each embodiment can provide an image processing apparatus that allows a user to check an image at a desired timing.

What is claimed is:

1. An image processing apparatus comprising:
an image sensor configured to detect an event in a case where a luminance change for each pixel exceeds a predetermined threshold value, and to output an event signal including information on a time of the event and a pixel position at which the event has occurred;
a drive unit configured to drive at least one of an optical member constituting at least a part of an imaging optical system and the image sensor so that the luminance change exceeds the predetermined threshold value; and
a processor configured to process the event signal output from the image sensor while the drive unit drives the at least one of the optical member and the image sensor, and to control a focus lens in the imaging optical system based on a processed image.

2. The image processing apparatus according to claim 1, wherein the drive unit changes an imaging position in the image sensor by driving the optical member or the image sensor.

3. The image processing apparatus according to claim 2, wherein the drive unit drives the optical member, and
wherein the optical member includes a shift lens or a vari-angle prism configured to deflect an optical axis of the imaging optical system.

4. The image processing apparatus according to claim 2, wherein the drive unit drives the image sensor, and
wherein the image sensor is movable in a direction including a component orthogonal to an optical axis of the imaging optical system.

5. The image processing apparatus according to claim 2, wherein the drive unit rotates and drives the imaging optical system and the image sensor in a pan direction and a tilt direction.

6. The image processing apparatus according to claim 2, wherein the drive unit drives the optical member, and
wherein the optical member is a light-amount adjusting unit configured to adjust a light amount passing through the imaging optical system.

7. The image processing apparatus according to claim 6, wherein the light-amount adjusting unit includes an aperture stop or a neutral density filter.

8. The image processing apparatus according to claim 2, wherein the drive unit drives the optical member,
wherein the optical member includes a zoom lens, and
wherein the image sensor outputs the event signal in a case where a focal length changes as the zoom lens moves in an optical axis direction of the imaging optical system.

9. The image processing apparatus according to claim 1, further comprising a setting unit configured to set a first mode and a second mode,
wherein in a case where the first mode is set, the drive unit drives the at least one of the optical member and the image sensor so that the luminance change exceeds the predetermined threshold value, and in a case where the second mode is set, the drive unit does not drive the optical member or the image sensor.

10. The image processing apparatus according to claim 1, further comprising:
a shake detector configured to detect shake of the image processing apparatus, and
a setting unit configured to set a first mode and a second mode,
wherein in a case where the first mode is set, the drive unit drives the at least one of the optical member and the image sensor so that the luminance change exceeds the predetermined threshold value, and, in a case where the second mode is set, the drive unit drives the at least one of the optical member and the image sensor to a target position generated based on an output signal from the shake detector.

11. The image processing apparatus according to claim 1, wherein the processor controls the focus lens in the imaging optical system based on the processed image and a drive amount of the optical member or image sensor by the drive unit.

12. The image processing apparatus according to claim 1, wherein the processor is configured to:
determine an in-focus state based on the processed image, and
change a threshold value that is used to determine the in-focus state based on a driving amount of the optical member or the image sensor by the drive unit.

13. An image pickup apparatus comprising:
an image processing apparatus; and
an imaging optical system,
wherein the image processing apparatus includes:
an image sensor configured to detect an event in a case where a luminance change for each pixel exceeds a predetermined threshold value, and to output an event signal including information on a time of the event and a pixel position at which the event has occurred,
a drive unit configured to drive at least one of an optical member constituting at least a part of an imaging optical system and the image sensor so that the luminance change exceeds the predetermined threshold value, and
a processor configured to process the event signal output from the image sensor while the drive unit drives the at least one of the optical member or the image sensor, and to control a focus lens in the imaging optical system based on a processed image.

14. An image processing method comprising:
driving an optical member constituting at least a part of an imaging optical system or an image sensor;
detecting an event in a case where a luminance change for each pixel of the image sensor exceeds a predetermined threshold value while the optical member or the image sensor is being driven;
outputting an event signal including information on a time of the event and a pixel position where the event has occurred;
processing the event signal output from the image sensor; and
controlling a focus lens in the imaging optical system based on a processed image.

15. A non-transitory computer-readable storage medium storing a program that causes a computer to execute the image processing method according to claim 14.
